(19) United States
(12) Patent Application Publication
(10) Pub. No.: US 2024/0140612 A1
(43) Pub. Date: May 2, 2024

(54) GEAR PUMP, DRIVE DEVICE AND ADJUSTABLE-PITCH PROPELLER

(71) Applicant: Rolls-Royce Deutschland Ltd & Co KG, Blankenfelde-Mahlow (DE)

(72) Inventors: Gideon Daniel VENTER, Berlin (DE); Franz MEYER, Berlin (DE)

(21) Appl. No.: 18/495,965

(22) Filed: Oct. 27, 2023

(30) Foreign Application Priority Data
Oct. 28, 2022 (DE) 10 2022 128 671.1

(51) Int. Cl. B64D 35/00; F04C 2/18; F15B 15/14

(52) U.S. Cl. CPC B64D 35/00; F04C 2/18; F15B 15/1447

(57) ABSTRACT

A gear pump is described with at least two intermeshing gearwheels which are each rotationally fixedly connected to a shaft and separate a suction side from a delivery side. The shafts are mounted in a housing. One of the shafts can be brought into active connection with a drive unit and the other of the shafts can be brought into active connection with a pressure-control device which is to be driven by the drive unit via the two shafts. Furthermore, a drive device with the gear pump is proposed for setting an angle of attack of propeller blades of an adjustable-pitch propeller. In addition, an adjustable-pitch propeller having the drive device is described.

This application claims priority to German Patent Application 102022128671.1 filed Oct. 28, 2022, the entirety of which is incorporated by reference herein.

The present disclosure concerns a gear pump with at least two intermeshing gearwheels which are each rotationally fixedly connected to a shaft and separate a suction side from a delivery side. The present disclosure furthermore concerns a drive device with such a gear pump for setting an angle of attack of propeller blades of an adjustable-pitch propeller. In addition, the present disclosure concerns an adjustable-pitch propeller having such a drive device.

In general, gear pumps constitute machines for conveying fluids and for force-transmitting drive of hydraulic motors. For this, gear pumps usually comprise a housing with an inlet and an outlet, and two gearwheels, one of which is driven. Depending on the arrangement and type of gearwheels, we distinguish between external gear pumps, internal gear pumps, annular gear pumps and screw-type pumps. In an external gear pump with involute toothing, the medium to be conveyed is transported into the gaps between the teeth and the housing. Because of the simple structure, external gear pumps are robust and economic.

Gear pumps are also used in the field of drive devices for so-called adjustable-pitch propellers, in order to adjust the angles of attack of propeller blades by means of hydraulic pressure. Such adjustable-pitch propellers are used amongst others as airscrews or ship's propellers. The pitch of the airscrews used in aviation may be adjusted by twisting the propeller blades on the ground or during flight. In principle, automatic or manual adjustment is possible. Also, the adjustable-pitch propeller may allow a pitch change which is stepless or has only specific steps.

For so-called fixed rotation speed propellers, the engine speed remains constant and the thrust is controlled only by adjustment of the angles of attack of the propeller blades. When required, the full engine power is then immediately available since there is no need to accelerate masses of the drive motor first.

Furthermore, by means of adjustable-pitch propellers, a thrust reversal and windmilling become possible, wherein during windmilling of propeller blades with the engine stopped, minimum air resistance occurs.

So far, known drive devices for setting an angle of attack of propeller blades of an adjustable-pitch propeller have been designed with a gear pump generating hydraulic pressure which supplies a pressure-control device to avoid cavitation. Such a pressure-control device (governor), like the gear pump, is driven via a so-called auxiliary gear which is connected to a drive shaft of a drive unit and to a drive shaft of the pressure-control device. The pressure-control device provides the hydraulic pressure necessary for adjusting the angles of attack of the propeller blades.

Disadvantageously, the previously known drive devices for adjustable-pitch propellers are complex in construction, take up a large amount of installation space, and are also characterized by a high total weight.

The present disclosure is based on the object of making previously known designs of gear pumps and drive devices, in particular for adjustable-pitch propellers, structurally simple, lightweight, low-cost and compact. In addition, the present disclosure is based on the object of providing an economic and compact adjustable-pitch propeller which also has a low total weight.

This object is achieved by means of a gear pump, a drive device and an adjustable-pitch propeller having the features of Patent claims 1, 9 and 26 respectively.

According to a first aspect of the present disclosure, a gear pump is provided, preferably an external gear pump, with at least two intermeshing gearwheels. The gearwheels are each rotationally fixedly connected to a shaft and separate a suction side from a delivery side of the gear pump. The shafts are mounted rotatably in a housing. One of the shafts can be brought into active connection with a drive unit and the other of the shafts can be brought into active connection with a pressure-control device which is to be driven by the drive unit via the two shafts.

Thus the gear pump according to the present disclosure has a further functionality in addition to the usual pump functions of conveying fluid, such as hydraulic fluid or oil, and providing an oil volume flow. The further function is to transfer the torque, present for drive at the gear pump, in the direction of a device actively connected to the gear pump, i.e. in the present case the pressure-control device. In other words, the intermeshing gearwheels of the gear pump transmit the drive moment of the gear pump, present at one of the shafts, to the other shaft of the gear pump which is coupled to a device to be driven.

By use of such a gear pump, in a structurally simple and compact fashion, it is achieved that the pressure-control device or any other device can be driven with the required drive power by a drive unit without a separate gear mechanism.

In an advantageous refinement of the gear pump according to the present disclosure, the delivery side of the gear pump can be fluidically connected to a supply line of the pressure-control device, and a line of the pressure-control device conducting control pressure can be fluidically connected to a line running through one of the shafts of the gear pump. In this embodiment of the gear pump according to the present disclosure, the gear pump has a further functionality. The further function of the gear pump is to conduct the fluid provided by the pressure-control device through one of the shafts of the gear pump in the direction of a hydraulic consumer. It is advantageous that the fluid of the pressure-control device can be conducted in the direction of a hydraulic consumer by the gear pump with little structural complexity, few sealing elements and a small number of components.

If a translation ratio between the gearwheels of the gear pump according to the present disclosure is not equal to one, the pressure-control device can be driven with the necessary rotation speed by the drive unit in the desired fashion.

The shafts of the gear pump according to the present disclosure may each be formed as hollow shafts, so that the shafts can be designed with a favourable ratio of component weight to component strength.

The shaft which is couplable to the pressure-control device to be driven may be configured with an internal or an external spline profile which can be brought into engagement with an external or an internal spline profile of a drive shaft or coupling shaft of the pressure-control device. Thus the gear pump according to the present disclosure can easily be connected to the pressure-control device.

The shafts of the gear pump according to the present disclosure may be rotatably mounted in the housing via bearing bushes, preferably plain bearing bushes. This provides a simple way for the bearing bushes to seal the suction side and the delivery side against the environment of the gear pump, against the line in the shaft and against the line of the pressure-control device conducting control pressure.

In the axial direction, between the bearing bush and the shaft end of the shaft which is couplable to the drive unit, a radial shaft seal ring may be provided. By means of the radial shaft seal ring, an axial gap between the shaft and the housing may be sealed in order, in a structurally simple fashion, to prevent an escape of fluid, such as hydraulic fluid or oil, from the housing of the gear pump.

In a refinement of the gear pump according to the present disclosure, the axial gap between the bearing bush and the radial shaft seal ring is connected to a substantially pressureless region via a vent line running in the housing. Thus in a simple fashion, it is guaranteed that, during operation of the gear pump, the radial shaft seal ring is not loaded with such a high fluid pressure as would reduce the sealing effect of the radial shaft seal ring.

According to a further aspect of the present invention, a drive device is operated with an above-described gear pump for setting an angle of attack of propeller blades of an adjustable-pitch propeller, in particular an adjustable-pitch propeller of an aircraft. Such a drive device has a structurally simple design and also requires only little installation space. Furthermore, the drive device according to the present disclosure is characterized by a low total weight.

One of the shafts of the gear pump may be rotationally fixedly connected to a drive shaft of a drive unit via a flexible connecting unit. Thus tilts and axial offsets occurring during operation between the shaft of the gear pump and the drive shaft, and the resulting constrictions which are also caused by alignment faults or production tolerances, can be compensated in simple fashion.

In a structurally simple embodiment of the drive device according to the present disclosure which can be mounted with little effort, the flexible connecting unit comprises axially, radially and angularly movable toothed clutches.

In an embodiment of the drive device which is compact and structurally simple, the toothed clutches have a common sleeve with an internal toothing, wherein a crowned external toothing of the drive shaft and also a crowned external toothing of the shaft of the gear pump each engage in a respective one of the internal toothings of the sleeve.

In an alternative embodiment of the drive device according to the present disclosure, the toothed clutches each have, in the region of respective shaft ends, a connecting shaft which is configured with crowned external toothing at the ends. Then it is possible that the crowned external toothings of the connecting shaft engage respectively in an internal toothing of the shaft of the gear pump and in an internal toothing of the drive shaft. Then firstly a drive moment of the drive unit can be transmitted, and secondly axial offsets between the drive shaft and the shaft of the gear pump can be compensated with little structural complexity.

The drive shaft of the drive unit may be configured with a line which, in the region of the connecting unit, is fluidically connected to the line of the shaft of the gear pump for conducting fluid from the shaft into the drive shaft. Such a drive device is characterized by a low number of components, which again has positive effects on the production costs and on the component weight of the drive device.

The connecting unit may comprise a sealing collar which radially surrounds the shaft end of the shaft of the gear pump facing the drive shaft of the drive unit. Furthermore, the sealing collar may also surround in the circumferential direction the shaft end of the drive shaft of the drive unit facing the shaft. The sealing collar then seals the transition for the fluid between the line of the shaft and the line in the drive shaft. This also offers, with little structural complexity, the possibility of compensating in structurally simple and economic fashion for the axial offsets between the rotational axes of the shaft and the drive shaft in the region of the connecting unit, and sealing the hydraulic path of the fluid or oil through the drive device against the environment to the desired extent.

Furthermore, it is also possible that a seal is provided, in the radial direction, between the sealing collar and the shaft end of the drive shaft, and between the sealing collar and the shaft end of the shaft of the gear pump. It may for example be provided that the seals are configured as U-shaped seals, the sealing effect of which increases as the pressure inside the sealing collar rises.

Conducting the oil through the shaft of the gear pump and the line of the drive shaft, in conjunction with the flexible connecting unit, offers in a simple fashion the possibility of sealing the oil path without a wear-promoting relative movement between the seals radially inside the sealing collar and radially outside the shaft of the gear pump and the drive shaft.

If, in the installation position of the drive device, below the gear pump in the vertical direction of the drive device, an oil reservoir is provided which fluidically connects the suction side of the gear pump and the axial gap, leakage oil can be introduced into or discharged from the oil reservoir under force of gravity by the gear pump and the hydraulic connection between the gear pump and the drive shaft, without additional structural complexity.

In an embodiment of the drive device characterized by a high power density, the drive unit of the drive device may be designed with an electrical machine.

The delivery side of the gear pump may be connected to a supply line of a pressure-control device, in the region of which a hydraulic control pressure for actuating an adjustable-pitch propeller is set in controlled fashion. Thus cavitation in the region of the suction side of the pressure-control device can be avoided in a simple fashion.

In addition, it is possible that a line of the pressure-control device conducting control pressure is connected to the line of the shaft. Thus an adjustable-pitch propeller can be actuated by the pressure-control device with few sealing elements and simultaneously low wear in the region of the seals.

The line conducting control pressure can be connected via a valve unit to the suction side of the gear pump and/or to the oil reservoir. In a structurally simple fashion, this offers the possibility of avoiding an unacceptably high pressure rise in the region of the pressure-control device. This is the case since surplus pressurized oil provided by the pressure-control device can be discharged in a structurally simple fashion into pressure regions of the drive device which each have a lower pressure level than the line of the pressure-control device conducting the control pressure.

If the oil is conducted for example from the line conducting control pressure at least partially in the direction of the delivery side of the gear pump, the drive device can be operated with high efficiency because of the suction loading of the gear pump.

If the oil escaping from the pressure-control device at control pressure is returned to the oil reservoir, an undesirably high temperature rise in the region of the gear pump and the pressure-control device can be avoided with little effort.

If a discharge line of the pressure-control device, via which leakage oil can be discharged from the pressure-control device, opens into the oil reservoir, an oil loss of the drive device is kept low in a structurally simple fashion.

In addition, it is possible for the gear pump to draw in oil via a suction line from a region of the oil reservoir in which a magnetic swarf detector is arranged, If an opening region of the suction line and the swarf detector are arranged in the oil reservoir such that the oil flows past the swarf detector before entering the suction line, metallic swarf carried into the oil reservoir by the oil is retained by the magnetic swarf detector. This offers the possibility, e.g. during maintenance of the drive device, of detecting wear in the region of the drive device if swarf is adhering to the swarf detector.

The oil reservoir may be sealed against the environment in order to prevent an undesired oil escape from the oil reservoir in the direction of the environment. If the oil reservoir is connected to the environment via a vent line, during operation of the drive device and during filling processes of the oil reservoir, undesirably high pressures in the interior of the oil reservoir can easily be avoided.

According to a further aspect of the present disclosure, an adjustable-pitch propeller is provided, with a drive device described in more detail above.

The line in the drive shaft of the drive unit may be connected to a hydraulic hydraulic adjustment unit comprising pistons which can be loaded with the hydraulic control pressure of the pressure-control device. The pistons may be configured to be adjustable by the hydraulic control pressure against springs in the axial direction, wherein angles of attack of propeller blades of the adjustable-pitch propeller according to the present invention vary depending on the axial positions of the pistons.

In a refinement of the adjustable-pitch propeller according to the present invention, the oil from the hydraulic adjustment unit can be conducted through the line of the drive shaft of the drive unit into the oil reservoir in order to vary the angles of attack of the propeller blades.

The present disclosure is not restricted to the indicated combination of features of the additional independent claims or claims dependent thereon. There are furthermore possibilities of combining individual features, including those which emerge from the claims, the following description of embodiments and directly from the drawing, with one another. The reference to the drawings by the claims through the use of reference designations is not intended to restrict the scope of protection of the claims.

Preferred refinements emerge from the dependent claims and the description hereunder. Exemplary embodiments of the subject matter according to the present disclosure are explained in greater detail with reference to the drawing, without being restricted thereto. In the drawing:

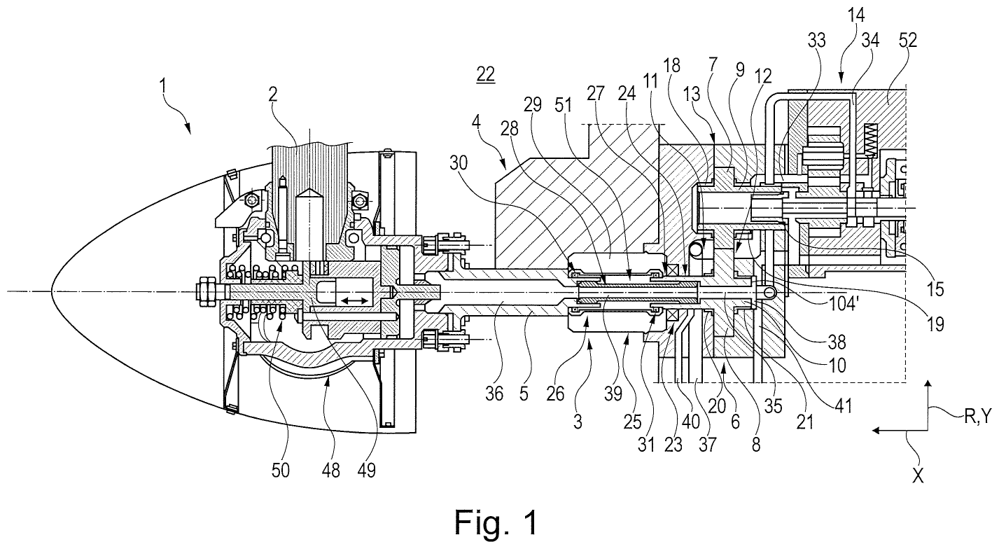

FIG. 1 shows a schematic, longitudinal sectional view of an adjustable-pitch propeller with a drive device configured with a gear pump;

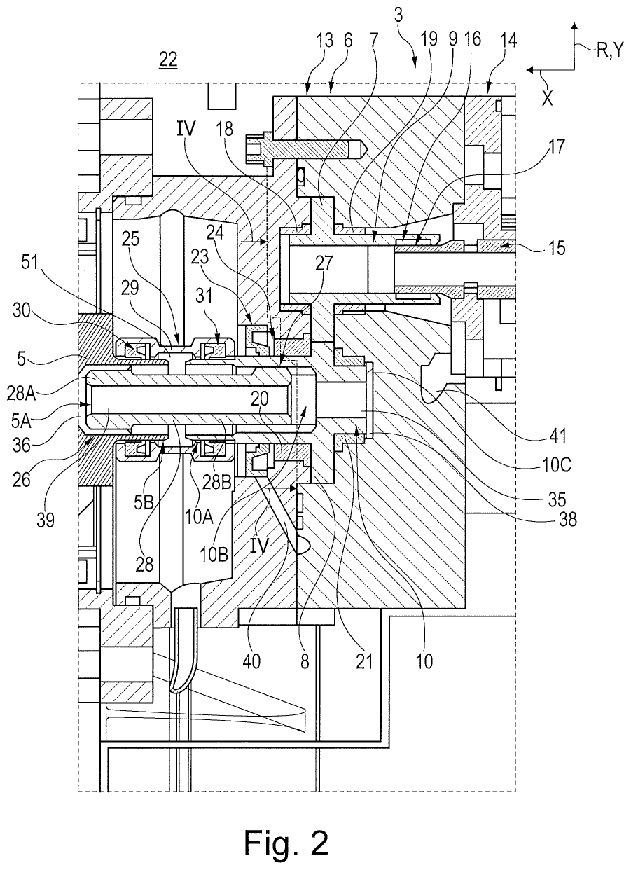

FIG. 2 shows an enlarged, partial sectional view of a region of the drive device from FIG. 1 which contains the gear pump;

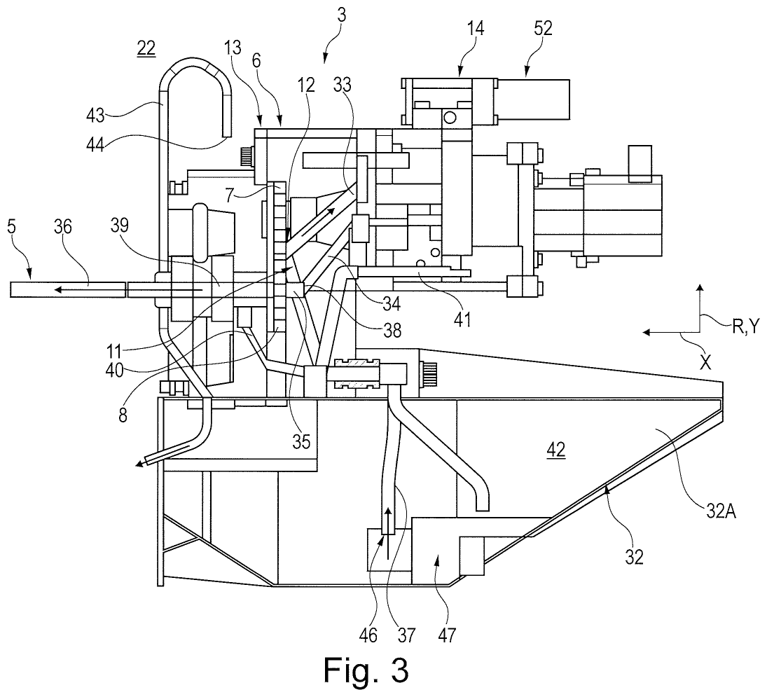

FIG. 3 shows a further simplified, partial sectional view of the drive device, in which several lines of the drive device are depicted;

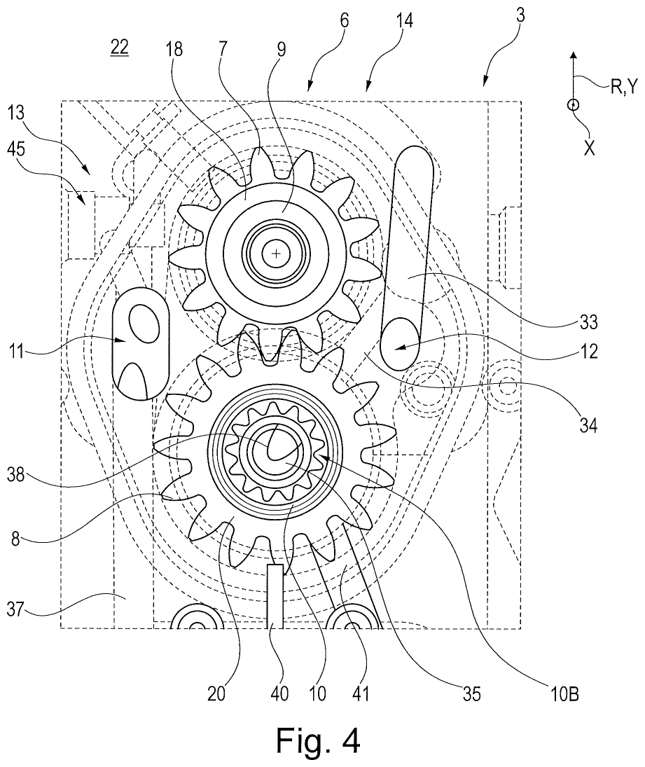

FIG. 4 shows an enlarged, three-dimensional sectional view of a further region of the drive device along a section line IV-IV denoted more specifically in FIG. 2;

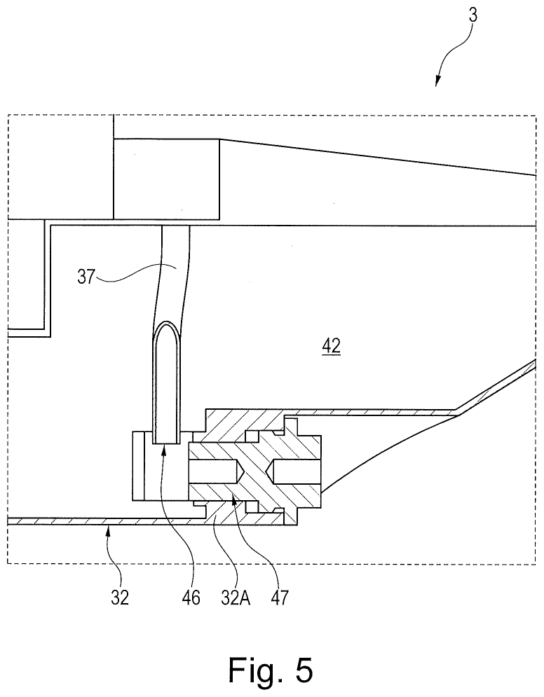

FIG. 5 shows an enlarged, partial, longitudinal sectional view of an oil reservoir of the drive device; and

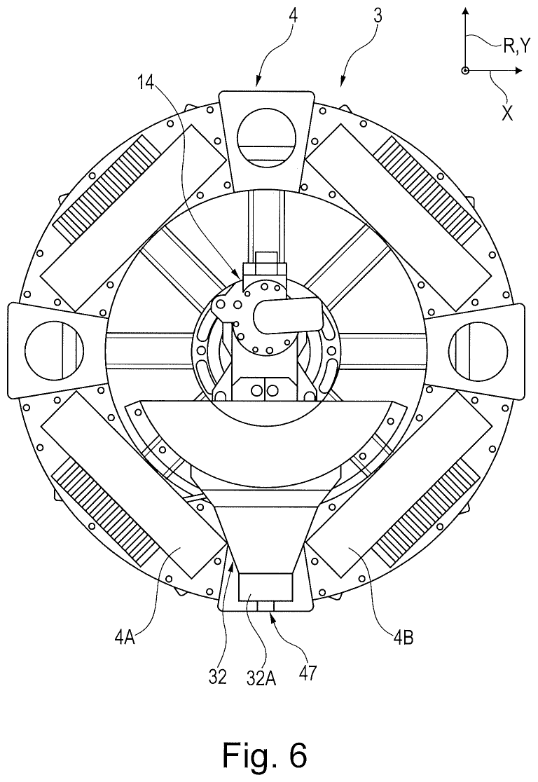

FIG. 6 shows a side view of a part of a drive device and the oil reservoir of the drive device.

FIG. 1 shows a greatly simplified illustration of an adjustable-pitch propeller 1, the propeller blades 2 of which can be actuated by a drive device 3 in order to vary an angle of attack of the propeller blades 2 and adapt this to different operating situations. In the exemplary embodiment illustrated in the drawing, the adjustable-pitch propeller 1 is an airscrew, the pitch of which can be adjusted on the ground or during flight of the aircraft equipped with the adjustable-pitch propeller 1.

The drive device 3 comprises a drive unit 4 which in this case is designed with an electric motor. A drive shaft 5 of the drive unit 4 is in driving connection with a hydraulic gear pump 6. The gear pump 6 is designed as an external gear pump.

The gear pump 6 here comprises two intermeshing gearwheels 7, 8. The gearwheels 7, 8 are each rotationally connected to a shaft 9, 10 in the manner illustrated in detail in FIG. 2, and separate a suction side 11 of the gear pump 6 from a delivery side 12 such that oil drawn in via the suction side 11 is compressed between the gearwheels 7, 8 and supplied to the delivery side 12 in the known manner.

The shaft 10 of the gearwheel 8 is rotationally fixedly connected to the drive shaft 5 of the drive unit 4. The shaft 9 of the gearwheel 7 is in driving connection with a pressure-control device 14 via a coupling shaft 15, in order for the drive unit 4 to be able to drive in rotation the pressure-control device 14, which constitutes a so-called propeller governor, via the gear pump 6. A translation ratio between the gearwheels 7 and 8 varies depending on the respective application, so that a rotation speed of the coupling shaft 15 can be set accordingly.

The translation ratio between the rotation speed of the gearwheel 7 and the rotation speed of the gearwheel 8 may have values in a range from 0.2 to 5, depending on application. The rotation speed of the drive shaft 5 in the region of the gear pump 6 is reduced for translation ratios greater than one, and the pressure-control device 14 is driven with a rotation speed of the coupling shaft 15 which is lower than the rotation speed of the drive shaft 5. In contrast, the rotation speed of the drive shaft 5 in the region of the gear pump 6 is increased for translation ratios of less than one, and the pressure-control device 14 is driven with a rotation speed of the coupling shaft 15 which is higher than the rotation speed of the drive shaft 5.

The shafts 9, 10, the drive shaft 5 and the coupling shaft 15 of the pressure-control device 14 are each configured as hollow shafts. The shaft 9 is configured with an internal spline profile 16 which is in engagement with an external spline profile 17 of the coupling shaft 15 or the drive shaft of the pressure-control device 14. Furthermore, the shafts 9 and 10 are mounted rotatably in the housing 13 of the gear pump 6 via bearing bushes 18, 19 and 20, 21. The bearing bushes 18, 19 and 20, 21 seal the suction side 11 and delivery side 12 against an environment 22 of the gear pump 6. In addition, in the axial direction X, between the bearing bush 20 of the shaft 10 and a shaft end 10A of the shaft 10, a radial shaft seal ring 23 is provided, by means of which an axial gap 24 between the shaft 10 and the housing 13 is sealed against an oil escape in the direction of the environment 22.

In this case, the shaft 10 is rotationally fixedly connected to the drive shaft 5 of the drive unit 4 via a flexible connecting unit 25. The flexible connecting unit 25 allows compensation for relative movements between the shaft 10 and the drive shaft 5. It is advantageous here that by compensating for relative movements between the drive shaft 5 and gearwheel 8, overloads and damage to the plain bearings in the region of the bearing bushes 18 to 21 can easily be avoided.

For this, the flexible connecting unit 25 has two axially, radially and angularly movable toothed clutches 26 and 27. The connecting unit 25 has a connecting shaft 28 which has crowned external toothings 28A, 28B at each end, constituting parts of the toothed clutches 26, 27. The crowned external toothing 28A of the connecting shaft 28 engages in an internal toothing 5A of the drive shaft 5, while the crowned external toothing 28B engages with an internal toothing 10B of the shaft 10. The dimensions of the crowned external toothings 28A and 28B of the connecting shaft 28 are the same, so as to avoid axial forces under static pressure conditions.

In addition, the connecting unit 25 has a sealing collar 29 which radially surrounds the shaft end 10A of the shaft 10 of the gear pump 6 facing the drive shaft 5 of the drive unit 4, and a shaft end 5B of the drive shaft 5 facing the shaft 10. In the radial direction R, a seal 30, 31 is provided respectively between the sealing collar 29 and the shaft end 5B of the drive shaft 5, and between the sealing collar 29 and the shaft end 10A of the shaft 10 of the gear pump 6. In this case, the seals 30, 31 are configured as U-shaped seal rings, the sealing effect of which increases with the rising pressure radially inside the sealing collar 29. On the outside of the drive shaft 5, a guide lip or similar may be provided so that the sealing collar 29 and seal 30 can easily be installed.

In the installation position of the drive device 3, below the gear pump 6 in the vertical direction Y of the drive device 3, an oil reservoir 32 is provided which fluidically connects the suction side 11 of the gear pump 6 and the axial gap 24.

The delivery side 12 of the gear pump 6 is fluidically connected to a supply line 33 of the pressure-control device 14. In addition, a line 34 of the pressure-control device 14 conducting control pressure is fluidically connected to a line 35 leading through the shaft 10. Furthermore, the drive shaft 5 is configured with a line 36 which, in the region of the connecting unit 25, is fluidically connected to the line 35 of the shaft 10 of the gear pump 6 for conducting fluid from the shaft 10 into the drive shaft 5.

During operation of the drive device 3 or adjustable-pitch propeller 1, the gear pump 6 draws in oil from the oil reservoir 32 via a suction line 37. In the region of the gear pump 6 driven by the drive unit 4 via the drive shaft 5 and shaft 10, the oil drawn in by the gear pump 6 is compressed in the known fashion by the intermeshing gearwheels 7 and 8 and conducted from the delivery side 12 into the supply line 33 of the pressure-control device 14. From the supply line 33 of the pressure-control device 14, the oil enters the pressure-control device 14, in the region of which the supplied oil is further compressed.

The oil compressed in the region of the pressure-control device 14 is conducted into the housing 13 of the gear pump 6 via the line 34 conducting control pressure. The line 34 conducting control pressure opens into a housing region 38 which is delimited by the housing 13 of the gear pump 6, an end face 10C of the shaft 10 and the bearing bush 21. The housing region 38 is fluidically connected to the line 35 of the shaft 10, whereby the oil is conducted from the line 34 conducting control pressure firstly into the housing region 38 and from there into the line 35 of the shaft 10.

The housing region 38 is sealed by the bearing bush 21 both against the housing 13 and also against the delivery side 12 of the gear pump 6. The pressurized oil flowing from the line 34 conducting control pressure into the line 35 is conducted into a line 39 of the connecting shaft 28 which is connected to the line 36 of the drive shaft 5.

The axial gap 24 between the bearing bush 20 and the radial shaft seal ring 23 is connected, in the manner shown in detail in FIG. 3, to the oil reservoir 32 via a vent line 40 running in the housing 13 of the gear pump 6. The oil reservoir 32 here constitutes a so-called pressureless region of the drive device 3, the internal pressure of which corresponds substantially to the atmospheric ambient pressure of the adjustable-pitch propeller 1. This prevents, in a simple fashion, unacceptably high pressures in the axial gap 24 which, if there were no vent line 40, would occur because of leakage oil entering the axial gap 24 from the delivery side 12 of the gear pump 6. In addition, a discharge line 41 of the pressure-control device 14 opens into the oil reservoir 32, via which leakage oil from the pressure-control device 14 can be returned to the oil reservoir 32. Furthermore, the oil reservoir 32 is configured with an oil level monitor, wherein the oil level monitor may be configured both with a sight glass and/or with an electronic fill level monitor.

To avoid an undesirable oil escape from the oil reservoir 32 towards the environment 22, the oil reservoir 32 is configured as a closed system or one which is sealed against the environment 22. However, to avoid an undesired pressure rise in the oil reservoir 32, an interior 42 of the oil reservoir 32 is connected to the environment 22 via a vent line 43. In the installation position of the adjustable-pitch propeller 1 in an aircraft, an opening region 44 of the vent line 43 is arranged above the oil reservoir 32 such that the opening region 44 lies above the oil reservoir 32 in all flight situations of an aircraft, i.e. in normal flight situations during horizontal flight, climbing or descent. Thus an oil escape from the oil reservoir 32 via the vent line 43 in the direction of the environment 22 is safely avoided.

FIG. 4 shows an enlarged, three-dimensional, partial sectional view of a region of the drive device 3 in which the gear pump 6 is arranged. The illustration in FIG. 3 shows that the line 34 of the pressure-control device 14 conducting control pressure can be connected via a valve unit 45 to the suction side 11 of the gear pump 6 so as to avoid, in structurally simple fashion, unacceptably high pressures in the region of the pressure-control device 14. The return of pressurized oil from the pressure-control device 14 towards the suction side 11 of the gear pump 6 is also energetically favourable, since less compression work must be performed in the region of the gear pump 6.

Depending on the concrete application, in combination therewith or alternatively, it is also possible to bring the line 34 of the pressure-control device 14 conducting control pressure into connection with the oil reservoir 32 via the valve unit 45, in order to discharge oil from the line 34 conducting control pressure so as to limit the pressure in the region of the pressure-control device 14. This has the advantage that surplus oil is not conducted into the circuit between the gear pump 6 and the pressure-control device 14, so does not heat up unacceptably during operation.

FIG. 5 shows an enlarged, partial sectional view of the oil reservoir 32 in which an opening region 46 of the suction line 37 is arranged in the interior 42 of the oil reservoir 32. In addition, in a lower region of the oil reservoir 32, a magnetic swarf detector 47 is provided on which, because of the magnetic effect, metal swarf carried into the oil reservoir 32 by the oil adheres. For this, the opening region 46 of the suction line 37 and the swarf detector 47 are arranged in the oil reservoir 32 matched to one another such that oil flows past the swarf detector 47 before entering the suction line 37. In a preferred embodiment of the drive device 3, the oil is drawn in by the gear pump 6 from the lowest position of the oil reservoir 32 just above the magnetic swarf detector 47, creating an oil volume stream which flows past the magnetic swarf detector 47.

The magnetic swarf detector 47 may be connected to the wall region 32A of the oil reservoir 32 for example via a bayonet connection or similar, and in addition have a self-sealing housing. Furthermore, the oil reservoir 32 can easily be filled with oil via the interface of the magnetic swarf detector 47, and the oil can also be drained from the oil reservoir via the interface of the swarf detector 47.

FIG. 6 also shows a rear view of the drive device 3 in which part of the drive unit 4 and the oil reservoir 32 are depicted. From the view in FIG. 6, it is clear that the oil reservoir 32 extends downward in the vertical direction Y between elements 4A and 4B of the drive unit 4, wherein the magnetic swarf detector 47 points downward and protrudes beyond a wall region 32A of the oil reservoir 32. Thus the magnetic swarf detector 47 can easily be removed from the oil reservoir 32 by an operator. By a visual inspection of the swarf detector 47, it can be verified whether any metallic swarf is present on the swarf detector 47 and whether mechanical wear has occurred, in particular in the region of the gear pump 6 and/or pressure-control device 14.

The line 36 of the drive shaft 5 of the drive unit 4 is connected to a hydraulic adjustment unit 48 of the adjustable-pitch propeller 1. The adjustment unit 48 comprises pistons 49 which can be adjusted in the axial direction against springs 50 by the hydraulic control pressure of the pressure-control device 14. The angles of attack of the propeller blades 2 here vary depending on the axial positions of the pistons 49.

Since the shaft 10 is rotationally fixedly connected to the drive shaft 5 of the drive unit 4 via the connecting shaft 28, the shaft 10 and the drive shaft 5, with the sealing collar 29 arranged thereon, rotate with the same rotation speed. This has the advantage that the sealing effect of the seals 30 and 31 acts sealingly on the shaft 10 and drive shaft 5 without differential rotation speeds which could cause wear. Thus in operation of the drive device 3, an escape of oil at the coupling point between the shaft 10 and the drive shaft 5 is avoided via the sealing collar 29 in a simple and wear-free fashion.

The oil introduced under pressure into the line 35 flows firstly through the line 39 of the connecting shaft 28 into the line 36 of the drive shaft 5. In addition, the oil flows out of the line 35 between the internal toothing 10B of the shaft 10 and the crowned external toothing 28B of the connecting shaft 28, in the direction of the radial space 51 delimited by the sealing collar 29. Furthermore, oil from the line 36 of the drive shaft 5 also reaches the radial space 51 between the internal toothing 5A of the drive shaft 5 and the crowned external toothing 28A of the connecting shaft 28.

The oil streams entering the radial space 51 cause an increase in pressure in the radial space 51 which acts on the seals 30 and 31. Since the two seals 30 and 31 are in this case configured as so-called U-shaped seals, the hydraulic pressure prevailing in the radial space 51 causes the seals 30 and 31 to deploy a desired high sealing effect. In addition, the tooth engagements between the connecting shaft 28 and drive shaft 5 and the shaft 10 are lubricated by oil entering the radial space 51.

To adjust the angles of attack of the propeller blades 2, it may also be provided that the pistons 49 are moved by the springs 50 against the hydraulic pressure provided by the line 36 of the drive shaft 5. Then the oil from the line 36 of the drive shaft 5 is returned to the line 39 of the connecting shaft 28. The oil is then conducted through the line 35 of the shaft 10 into the line 34 of the pressure-control device 14 conducting control pressure, and from there into the discharge line 41. The oil is returned to the oil reservoir 32 via the discharge line 41.

This return of pressurized oil during adjustment of the propeller blades 2 offers the additional possibility of venting the lines 36, 35 with little effort, since air introduced into the lines 34, 39 and 36 by the pressure-control device 14 can then easily be flushed out with the oil in the direction of the oil reservoir 32. This is the case since the air introduced into the radial space 51, and also the air flowing into the lines 35, 39 and 36 with the oil, is conveyed radially inward during operation of the drive device 3 by the centrifugal force which acts on the oil and air during operation.

The gearwheels 7 and 8 of the gear pump are in this case used to measure the rotation speed. A rotation speed sensor measures the rotation speed of the pressure-control device 14 on the delivery side 12 of the gear pump 6.

A housing 52 of the pressure-control device 14 serves as an interface and holder for the pressure-control device 14. This offers the possibility of configuring the drive device 3 such that the gear pump 6 and the pressure-control device 14 can be installed and removed as a pre-assembled unit. Thus after removal of the oil reservoir 32, the gear pump 6 can be removed together with the pressure-control device 14. For this, the oil reservoir 32 is bolted to the back of the drive unit 4.

### LIST OF REFERENCE SIGNS

1 Adjustable-pitch propeller
2 Propeller blade
3 Drive device
4 Drive unit
4A, 4B Elements of drive unit
5 Drive shaft
5A Internal toothing of drive shaft
5B Shaft end of drive shaft
6 Gear pump
7, 8 Gearwheel of gear pump
9 Shaft of gear pump
10 Shaft of gear pump
10A Shaft end of shaft 10
10B Internal toothing of shaft 10
10C End face of shaft 10
11 Suction side of gear pump
12 Delivery side of gear pump
13 Housing of gear pump
14 Pressure-control device
15 Coupling shaft of pressure-control device
16 Internal spline profile of shaft 9
17 External spline profile of coupling shaft 15
18, 19 Bearing bush of shaft 9
20, 21 Bearing bush of shaft 10
22 Environment of drive device
23 Radial shaft seal ring
24 Axial gap
25 Connecting unit
26 Toothed clutch
27 Toothed clutch
28 Connecting shaft
28A, 28B Crowned external toothing of connecting shaft 28
29 Sealing collar
30, 31 Seal of sealing collar
32 Oil reservoir
32A Wall region of oil reservoir
33 Supply line of pressure-control device
34 Line of pressure-control device conducting control pressure
35 Line of shaft 10
36 Line of drive shaft 5
37 Suction line of gear pump
38 Housing region of gear pump 6
39 Further line of connecting shaft 28
40 Vent line of axial gap 24
41 Discharge line of pressure-control device
42 Interior of oil reservoir
43 Vent line of oil reservoir
44 Opening region of vent line 43
45 Valve unit
46 Opening region of suction line 37
47 Magnetic swarf detector
48 Hydraulic adjustment unit
49 Piston of hydraulic adjustment unit
50 Spring of hydraulic adjustment unit
51 Radial space of sealing collar
52 Housing of pressure-control device
R Radial direction
X Axial direction
Y Vertical direction

1. A gear pump with at least two intermeshing gearwheels which are each rotationally fixedly connected to a shaft and separate a suction side from a delivery side, wherein the shafts are mounted rotatably in a housing, and wherein one of the shafts can be brought into active connection with a drive unit and the other of the shafts can be brought into active connection with a pressure-control device which is to be driven by the drive unit via the two shafts.

2. The gear pump according to claim 1, wherein the delivery side can be fluidically connected to a supply line of the pressure-control device, and a line of the pressure-control device conducting control pressure can be fluidically connected to a line leading through one of the shafts.

3. The gear pump according to claim 1, wherein a translation ratio between the gearwheels is not equal to one.

4. The gear pump according to claim 1, wherein the shafts are each formed as hollow shafts.

5. The gear pump according to claim 1, wherein the shaft which is couplable to the pressure-control device to be driven is configured with an internal or an external spline profile which can be brought into engagement with an external or an internal spline profile of a drive shaft of the pressure-control device.

6. The gear pump according to claim 1, wherein the shafts are rotatably mounted in the housing via bearing bushes, wherein the bearing bushes seal the suction side and the delivery side against the environment and against the line in the shaft and against the line of the pressure-control device conducting control pressure.

7. The gear pump according to claim 6, wherein in the axial direction, between the bearing bush and the shaft end of the shaft which is couplable to the drive unit, a radial shaft seal ring is provided, by means of which an axial gap between the shaft and the housing is sealed.

8. The gear pump according to claim 7, wherein the axial gap between the bearing bush and the radial shaft seal ring is connected to a substantially pressureless region via a vent line running in the housing.

9. A drive device for setting an angle of attack of propeller blades of an adjustable-pitch propeller, with a gear pump according to claim 1.

10. The drive device according to claim 9, wherein one of the shafts of the gear pump is rotationally fixedly connected to a drive shaft of a drive unit via a flexible connecting unit.

11. The drive device according to claim 10, wherein the flexible connecting unit comprises axially, radially and angularly movable toothed clutches.

12. The drive device according to claim 11, wherein the toothed clutches have a sleeve with an internal toothing, which engages both with a crowned external toothing of the drive shaft and also with a crowned external toothing of the shaft of the gear pump.

13. The drive device according to claim 11, wherein the toothed clutches have a connecting shaft which is configured with crowned external toothing at the ends, wherein the crowned external toothings of the connecting shaft engage with the respective internal toothings of the shaft of the gear pump and of the drive shaft.

14. The drive device according to claim 10, wherein the drive shaft is configured with a line which, in the region of the connecting unit, is fluidically connected to the line of the shaft of the gear pump for conduction of fluid from the shaft into the drive shaft.

15. The drive device according to claim 10, wherein the connecting unit comprises a sealing collar which radially surrounds the shaft end of the shaft of the gear pump facing the drive shaft of the drive unit, and the shaft end of the drive shaft of the drive unit facing the shaft, and seals the transition for the fluid between the line of the shaft and the line in the drive shaft.

16. The drive device according to claim 15, wherein a seal is provided, in the radial direction, between the sealing collar and the shaft end of the drive shaft and between the sealing collar and the shaft end of the shaft of the gear pump.

17. The drive device according to claim 9, wherein in the installation position of the drive device, below the gear pump in the vertical direction of the drive device, an oil reservoir is provided which fluidically connects the suction side of the gear pump and the axial gap.

18. The drive device according to claim 10, wherein the drive unit comprises an electrical machine.

19. The drive device according to claim 9, wherein the delivery side of the gear pump is connected to a supply line of a pressure-control device, in the region of which a hydraulic pressure for actuating an adjustable-pitch propeller is set in controlled fashion.

20. The drive device according to claim 19, wherein a line of the pressure-control device conducting control pressure is connected to the line of the shaft.

21. The drive device according to claim 20, wherein the line conducting control pressure can be connected via a valve unit to the suction side of the gear pump and/or to the oil reservoir.

22. The drive device according to claim 19, wherein a discharge line of the pressure-control device, via which leakage oil can be discharged from the pressure-control device, opens into the oil reservoir.

23. The drive device according to claim 17, wherein the gear pump draws in oil via a suction line from a region of the oil reservoir in which a magnetic swarf detector is arranged, wherein an opening region of the suction line and the swarf detector are arranged in the oil reservoir such that the oil flows past the swarf detector before entering the suction line.

24. The drive device according to claim 17, wherein the oil reservoir is sealed against the environment and connected to the environment via a vent line.

25. An adjustable-pitch propeller having a drive device according to claim 9.

26. The adjustable-pitch propeller according to claim 25, wherein the line in the drive shaft of the drive unit is connected to a hydraulic adjustment unit comprising pistons which can be loaded with the hydraulic control pressure of the pressure-control device and adjusted by the hydraulic control pressure against springs in the axial direction, wherein angles of attack of propeller blades vary depending on the axial positions of the pistons.

27. The adjustable-pitch propeller according to claim 26, wherein oil from the hydraulic adjustment unit can be conducted through the line of the drive shaft of the drive unit into the oil reservoir in order to vary the angles of attack of the propeller blades.
